(19) United States
(12) Patent Application Publication
(10) Pub. No.: US 2008/0114805 A1
(43) Pub. Date: May 15, 2008

(54) PLAY LIST CREATOR

(76) Inventor: Lars Bertil Nord, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/558,539

(22) Filed: Nov. 10, 2006

(51) Int. Cl. G06F 17/30

(52) U.S. Cl. 707/104.1; 707/E17.009

(57) ABSTRACT

A method for creating a media content play list using electronic equipment includes analyzing the media content to develop an identifier indicative of a characteristic of the media content; and creating the media content play list based on a correlation between the identifier and a predefined characteristic.

### TECHNICAL FIELD OF THE INVENTION

The present invention relates generally to electronic equipment, such as electronic equipment for engaging in voice communications and/or for playing back audiovisual content to a user. More particularly, the invention relates to a device and method for creating a media content play list for a user of a mobile radio terminal.

### DESCRIPTION OF THE RELATED ART

Mobile and/or wireless items of electronic equipment are becoming increasingly popular. For example, mobile telephones are now in wide-spread use. In addition, the features associated with certain types of electronic equipment have become increasingly diverse. To name a few examples, many electronic equipment include cameras, text messaging capability, Internet browsing functionality, electronic mail capability, video playback capability, audio playback capability, image display capability and hands-free headset interfaces.

Media content, such as audio and/or visual media content, may be transferred to the electronic equipment for play back at a later time. This transfer may be in the form of a communication link established between the electronic equipment and another device (e.g., a short range communication link between the electronic equipment and a PC, another electronic equipment, etc.). Alternatively, the media content may be transferred between devices via a removable memory card. Yet another means for transferring media content to the electronic equipment may be via an internet connection with a music server (e.g., via a music purchasing service or the like). Another means for transferring media content may be via podcast. As will be appreciated, there are numerous ways in which media content may be transferred to/from electronic equipment.

Regardless of the manner in which the media content may be delivered to the electronic equipment, there may be a significant quantity of media content stored on the electronic equipment, which can be problematic when looking for a particular type or types of media content.

### SUMMARY

Physical memory available on electronic equipment continues to increase. Users of such electronic equipment usually take advantage of this increased memory by storing media content therein. While the increased memory is advantageous in the sense that it enables more and more media content to be stored on the electronic equipment, it can have some drawbacks. For example, as the amount of media content stored on the electronic equipment increases, it becomes increasingly difficult to find specific media content. In particular, if a user wishes to create a play list that suits a particular need (e.g., a play list that includes dance music, dinner music, etc.), then, to create the play list, the user first scrolls through the list of media content and reads each title and/or artist (or even plays a portion of the media content). Then, based on the title and/or artist, the user makes a decision as to whether that particular media content suits the particular need (e.g., is it a dance song?). Then, the user either selects the media content as part of the play list, or continues to scroll through the list. As will be appreciated, this process can be time consuming, particularly if a large play list is desired and/or if a large amount of media content is stored on the electronic equipment.

The present invention provides a method and apparatus that enables automatic creation of a media content play list, wherein the play list meets criteria desired by the user. For example, a user may wish to assemble a group of songs that have a particular beat or set a particular mood (e.g., dance music, dinner music, party music, workout music, etc.). The user may enter a keyword into the electronic equipment (e.g., dance) or otherwise select from a plurality of predefined categories, and then the electronic equipment analyzes the media content stored on the electronic equipment relative to the keyword or selected category. The analysis may be based on metadata associated with the media content, or the analysis may be based on characteristics of the media content itself (e.g., a beat, tempo, frequency response, etc.). Based on the analysis, the electronic equipment builds a play list that satisfies the user's criteria (e.g., the play list will include dance music if the user entered “dance” as the keyword). Further, the electronic equipment may recommend other media content not found on the electronic equipment, and may prompt the user whether or not they wish to purchase this media content.

According to one aspect of the invention, a method for creating a media content play list using electronic equipment includes analyzing the media content to develop an identifier indicative of a characteristic of the media content; and creating the media content play list based on a correlation between the identifier and a predefined characteristic or criteria.

According to one aspect of the invention, analyzing the media content to develop the identifier includes using at least one of a spectrum analyzer or a beat tracker to develop the identifier.

According to one aspect of the invention, using the beat tracker includes using multiple beat tracking algorithms to identify a beat of the media content.

According to one aspect of the invention, analyzing the media content includes classifying the media content into groups based on the identifier.

According to one aspect of the invention, creating the media content play list includes selecting media content from groups that are the same or similar to the predefined characteristics.

According to one aspect of the invention, creating the media content play list includes applying user definable rules to create the play list.

According to one aspect of the invention, creating the media content play list includes obtaining or deriving the predefined characteristic from data remote from the electronic equipment.

According to one aspect of the invention, the predefined characteristic can be made available to a plurality of electronic equipment.

According to one aspect of the invention, creating the media content play list can further include using metadata to create the play list.

According to one aspect of the invention, the predefined characteristic is defined by a key word entered into the electronic equipment or a category selectable from a plurality of predefined categories on the electronic equipment.

According to one aspect of the invention, the media content comprises at least one of audio content or video content.

According to one aspect of the invention, creating the media content play list includes suggesting media content not stored on the electronic equipment.

According to one aspect of the invention, the method further includes purchasing the suggested media content.

According to one aspect of the invention, a method of creating a media content play list using electronic equipment, includes determining at least one audible or visual characteristic of media content stored on or available to the electronic equipment; creating the media content play list based on a correlation between the at least one audible or visual characteristic and a predefined characteristic, rule or criteria.

According to one aspect of the invention, an electronic equipment includes a radio circuit operative to establish wireless communications with other electronic equipment; and a play list creation circuit operative to analyze media content to develop an identifier indicative of a characteristic of the media content, and to create a media content play list based on a correlation between the identifier and a predefined characteristic or criteria.

According to one aspect of the invention, the play list creation circuit comprises at least one of a spectrum analyzer or a beat tracker.

According to one aspect of the invention, the media content comprises at least one of audio content or video content.

According to one aspect of the invention, the beat tracker includes multiple beat tracking algorithms.

According to one aspect of the invention, the play list creation circuit classifies the media content into groups based on the identifier.

According to one aspect of the invention, the play list creation circuit selects media content from groups that are the same or similar to the predefined characteristics.

According to one aspect of the invention, the play list creation circuit further applies predefined rules to create the play list.

According to one aspect of the invention, the play list creation circuit is operative to obtain or derive the predefined characteristic from data remote from the electronic equipment.

According to one aspect of the invention, the play list creation circuit is operative to suggest media content not stored on the electronic equipment.

According to one aspect of the invention, the electronic equipment is a mobile telephone.

According to one aspect of the invention, a computer program embodied on a computer readable medium for creating a media content play list includes code that analyzes the media content to develop an identifier indicative of a characteristic of the media content; and code that creates the media content play list based on a correlation between the identifier and a predefined characteristic, rule or criteria.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic view of a mobile telephone as an exemplary electronic equipment in accordance with an embodiment of the present invention.

FIG. 2 is a schematic block diagram of the relevant portions of the mobile telephone of FIG. 1 in accordance with an embodiment of the present invention.

FIG. 3 is a schematic diagram of a communications system in which the mobile telephone of FIG. 1 may operate.

FIG. 4 is a flow chart of an exemplary media content play list creation function in accordance with the present invention.

### DETAILED DESCRIPTION OF EMBODIMENTS

The term “electronic equipment” includes portable radio communication equipment. The term “portable radio communication equipment,” which herein after is referred to as a “mobile radio terminal,” “mobile phone,” “mobile device,” or “mobile terminal”, and the like, includes all equipment such as mobile telephones, pagers, communicators, i.e., electronic organizers, personal digital assistants (PDAs), smartphones, portable communication apparatus or the like.

In the present application, the invention is described primarily in the context of a mobile phone. However, it will be appreciated that the invention is not intended to be limited to a mobile phone and can be any type of electronic equipment.

As used herein, media content includes audio content (e.g., music and/or speech utilizing various formats including mp3, wmv, etc.) and/or video content (e.g., photographs or images, movies using no compression or various compression techniques such as mpeg, divx, etc.).

The present invention will now be described with reference to the drawings, wherein like reference numerals are used to refer to like elements throughout.

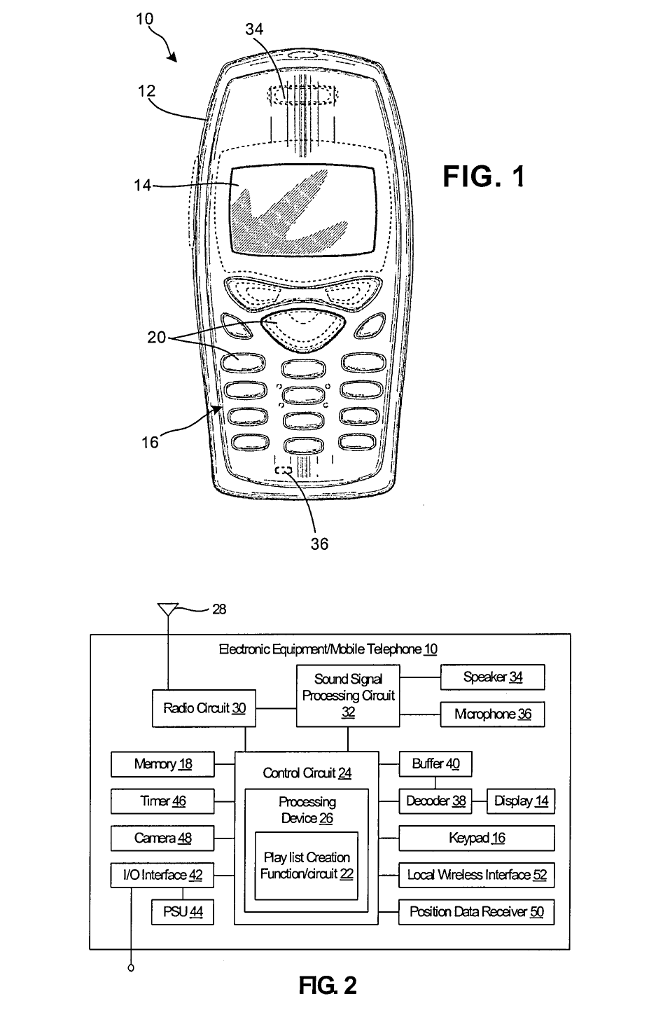

Referring initially to FIG. 1, an electronic equipment 10 is shown in accordance with the present invention. The electronic equipment includes a play list creation function that is configured to provide media content play lists tailored to a user's preferences. It will be appreciated that the media content play list function may be embodied as executable code that may be resident in and executed by the electronic equipment 10.

The electronic equipment in the exemplary embodiment is a mobile telephone and will be referred to as the mobile telephone 10. The mobile telephone 10 is shown as having a “brick” or “block” form factor housing 12, but it will be appreciated that other type housings, such as a clamshell housing or a slide-type housing, may be utilized without departing from the scope of the invention.

The mobile telephone 10 includes a display 14 and keypad 16. As is conventional, the display 14 displays information to a user such as operating state, time, telephone numbers, contact information, various navigational menus, etc., which enable the user to utilize the various feature of the mobile telephone 10. The display 14 may also be used to visually display content received by the mobile telephone 10 and/or retrieved from a memory 18 (FIG. 2) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys such as a “call send” key for initiating or answering a call, and a “call end” key for ending or “hanging up” a call. Special function keys may also include menu navigation keys, for example, for navigating through a menu displayed on the display 14 to select different telephone functions, profiles, settings, etc., as is conventional. Other keys associated with the mobile telephone may include a volume key, an audio mute key, an on/off power key, a web browser launch key, a camera key, etc. Keys or key-like functionality may also be embodied as a touch screen associated with the display 14.

The mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 2 represents a functional block diagram of the mobile telephone 10. With the exception of a play list creation function 22, which is preferably implemented as executable logic in the form of application software or code within the mobile telephone 10, the construction of the mobile telephone 10 is otherwise generally conventional. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out conventional operation of the mobile telephone 10. The memory 18 may be, for example, one or more of a buffer, a flash memory, a hard drive, a removable media, a volatile memory, a non-volatile memory or other suitable device. In addition, the processing device 26 executes code in order to perform the play list creation function 22.

It will be apparent to a person having ordinary skill in the art of computer programming, and specifically in applications programming for mobile telephones or other items of electronic equipment, how to program a mobile telephone 10 to operate and carry out the functions described herein. Accordingly, details as to the specific programming code have been left out for sake of brevity. Also, while the play list creation function 22 is executed by the processing device 26 in accordance with the preferred embodiment of the invention, such functionality could also be carried out via dedicated hardware, firmware, software, or combinations thereof, without departing from the scope of the invention. Any of these implementations may be referred to a play list creation circuit. Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications system, as well as to receive audiovisual content. For example, the receiver may be an IP datacast compatible receiver compatible with a hybrid network structure providing mobile communications and DVB-H based or similar services. Other receivers for interaction with a mobile radio network or broadcasting network are possible and include, for example, GSM, CDMA, WCDMA, MBMS, WiFi, WiMax, DVB-H, ISDB-T, etc.

The mobile telephone 10 further includes a sound signal processing circuit 32 for processing audio signals transmitted by/received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation.

The mobile telephone 10 also includes the aforementioned display 14 and keypad 16 coupled to the control circuit 24. The display 14 may be coupled to the control circuit 24 by a video decoder 38 that converts video data to a video signal used to drive the display 14. The video data may be generated by the control circuit 24, retrieved from a video file that is stored in the memory 18 or derived from an incoming video data stream received by the radio circuit 30. Prior to being fed to the decoder 38, the video data may be buffered in a buffer 40.

The mobile telephone 10 further includes one or more I/O interface(s) 42. The I/O interface(s) 42 may be in the form of typical mobile telephone I/O interfaces and may include one or more electrical connectors. As is typical, the I/O interface(s) 42 may be used to couple the mobile telephone 10 to a battery charger to charge a battery of a power supply unit (PSU) 44 within the mobile telephone 10. In addition, or in the alternative, the I/O interface(s) 42 may serve to connect the mobile telephone 10 to a wired personal hands-free adaptor (not shown). Further, the I/O interface(s) 42 may serve to connect the mobile telephone 10 to a personal computer or other device via a data cable. The mobile telephone 10 may receive operating power via the I/O interface(s) 42 when connected to a vehicle power adapter or an electricity outlet power adapter.

The mobile telephone 10 may also include a timer 46 for carrying out timing functions. Such functions may include timing the durations of calls, generating the content of time and date stamps, etc. The mobile telephone 10 may include a camera 48 for taking digital pictures and/or movies. Image and/or video files corresponding to the pictures and/or movies may be stored in the memory 18. The mobile telephone 10 also may include a position data receiver 50, such as a global positioning system (GPS) receiver, Galileo satellite system receiver or the like. The mobile telephone 10 also may include a local wireless interface 52, such as an infrared transceiver and/or an RF adaptor (e.g., a Bluetooth adapter), for establishing communication with an accessory, hands-free adaptor, another mobile radio terminal, computer or other device.

The mobile telephone 10 may be configured to transmit, receive and process data, such as text messages (e.g., a short message service (SMS) formatted message), electronic mail messages, multimedia messages (e.g., a multimedia messaging service (MMS) formatted message), image files, video files, audio files, ring tones, streaming audio, streaming video and so forth. Processing such data may include storing the data in the memory 18, executing applications to allow user interaction with data, displaying video and/or image content associated with the data, broadcasting audio sounds associated with the data and so forth.

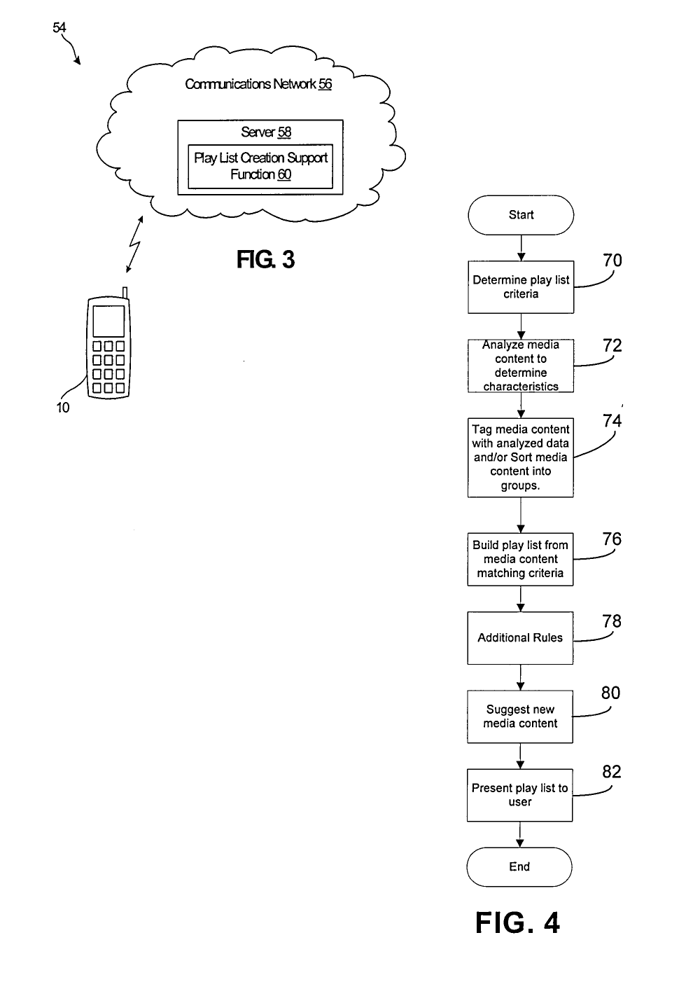

With additional reference to FIG. 3, the mobile telephone 10 may be configured to operate as part of a communications system 54. The system 54 may include a communications network 56 having a server 58 (or servers) for managing calls placed by and destined to the mobile telephone 10, transmitting data to the mobile telephone 10 and carrying out any other support functions. The server communicates with the mobile telephone 10 via a transmission medium. The transmission medium may be any appropriate device or assembly, including, for example, a communications tower, another mobile telephone, a wireless access point, a satellite, etc. Portions of the network may include wireless transmission pathways. The network 56 may support the communications activity of multiple mobile telephones 10, although only one mobile telephone 10 is shown in the illustration of FIG. 3.

In one embodiment, the server 58 may operate in stand alone configuration relative to other servers of the network 52 or may be configured to carry out multiple communications network 58 functions. As will be appreciated, the server 58 may be configured as a typical computer system used to carry out server functions and may include a processor configured to execute software containing logical instructions that embody the functions of the server 58. Those functions may include functions that are complimentary to the operation of the play list creation function 22 of the mobile telephone 10, and will be collectively referred to as a play list creation support function 60.

Referring now to FIG. 4, a method of creating a media content play list for a user of the mobile telephone 10 is depicted. The exemplary method of FIG. 4 describes the creation of a music play list for the user. It will be appreciated that the method may be adapted to recommend other types of media content, including, for example, video content, textual content, image content, etc. in various forms of delivery (e.g., from memory on the mobile telephone, via radio stations, podcasts, etc, to the user. Therefore, while the description herein refers to creating music play lists, the invention is not limited a single type of media.

Further while the play list creation function 22 is described as residing primarily on the mobile telephone 10, it may reside in other locations. For example, the play list creation function 22 may reside entirely on the server 58, or on another PC (not shown). Once the play list has been created, the server 58 and/or PC may transfer the play list to the mobile telephone 10. Additionally, portions of the functionality of the method may be carried out by the mobile telephone 10 and portions of the functionality of the method may be carried out by the server 58. For example, the functionality of the method may be embodied as executable code, such as in the form of the play list creation function 22 and/or the play list creation support function 60, or any other suitable form, including software, firmware, dedicated circuit components, a program stored on a computer readable media or in machine usable medium, and so forth.

Although the illustrated method shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The method may begin in block 70 where predefined criteria are specified or otherwise determined. Predefined criteria refer to rules that define characteristics of the media content. The rules can be based on metadata, beat, instrumentals, user preferences, etc. The predefined criteria may be desired characteristics of media content included within the play list. For example, one predefined criterion may be a particular type or genre of music (e.g., dance, heavy metal, rock) or a particular type of movie (e.g., action, drama, horror), or a user defined (e.g., dinner music, work out music, etc.).

The predefined criteria may be entered into the mobile telephone 10 via keypad 16, for example, wherein a user may manually enter the criteria using alphanumeric keys (e.g., spelling out the criteria such as “dance music”) or selecting the criteria from a predefined or previously created list.

Alternatively, the predefined criteria may be obtained from a remote source, such as server 58. For example, a promotion may be initiated wherein a famous person's music play list is made available to the general public. The mobile telephone 10 can access the server 58 via communications network 56 and transfer the play list from the server 58 to the mobile phone 10. Then, the play list and/or media content (e.g., music files) specified in the play list can be analyzed to determine the type of music specified therein. The analysis may be based on data stored within the play list itself. For example, the play list may include data that identifies the title, artist, genre, or other characteristics of the media content.

If such data is not present within the downloaded play list, the play list and/or media content may be analyzed so as to determine characteristics of the media content. For example, the mobile phone 10 may scan the media content stored in memory 18 relative to the media content specified in the downloaded play list. If one or more characteristics of the stored media content (e.g., artist name, song title, etc.) matches one or more characteristics of the media content specified in the play list, then the matching content may be flagged for further analysis. This further analysis can include review of metadata associated with the “matching” media content stored in memory 18. Based on information contained with the metadata of the matching content or other information, characteristics of the media content specified in the downloaded play list can be ascertained.

For example, when a song title and/or artist name of media content stored in memory 18 matches media content specified in the downloaded play list, the metadata associated with the stored media content can be extracted and analyzed. From the metadata, characteristics can be ascertained, such as, for example, a type or genre of the content, artist name, song name, etc. The downloaded music play list then can be said to have these same characteristics, and these characteristics can be used to build a new play list.

Additionally, the order and/or type of media content within the play list may form part of the predetermined criteria (e.g., a dance song followed by a rock song followed by a video). For example, a DJ may order songs to create a particular effect (e.g., increasing the intensity of the music for each subsequent song, or transitions between one style of music and another). This ordering of the media content, which can describe all or part of the predetermined criteria, can be determined by the mobile phone, which then may create a new play list that includes or otherwise mimics the same characteristics of the original or source play list.

Once the predefined criteria have been specified or otherwise determined, then at block 72 characteristics of the media content stored in memory 18 can be obtained. The characteristics can be obtained or determined, for example, from metadata associated with the media content. The metadata may include information such as the song name, artist name, type of music, etc. Typically, such metadata is included with or attached to the media content file itself, and can be easily analyzed by the processing device 26 of the mobile telephone 10 (e.g., the data can be extracted and/or decoded using conventional techniques).

Alternatively, characteristics of the media content may be developed or derived from the media content itself. For example, the media content's audio and/or video data may be analyzed to determine characteristics of the media content. A digital spectrum analyzer, for example, can be implemented within the mobile phone 10 and used to analyze the media content to obtain characteristics thereof. As is well known, a digital spectrum analyzer typically uses Fast Fourier transforms (FFT) to transform a waveform into the components of its frequency spectrum.

Acoustic spectrum analysis, for example, involves decomposing an input spectrum into different frequency components as a function of time. The conventional approach to acoustic spectrum analysis is to use digital signal processing (DSP) to analyze the spectrum of the signal of interest. DSP typically uses the FFT methodology to quickly translate time-domain signals and provide a frequency-domain spectrum.

From the frequency spectrum, characteristics of the media content can be determined. These characteristics can include, for example, a beat, tempo, frequency range, etc. of the media content. Further, the presence or absence of human voice or vocals can be ascertained, which can be used to determine if a musical piece is an instrumental piece.

Characteristics of media content also may be determined via other means. For example, a beat tracker is useful for media content embodied as music. While a basic beat tracker algorithm may provide satisfactory results in estimating a beat or tempo of media content, accuracy can be improved using multiple beat-tracking algorithms (e.g., a plurality of algorithms).

For example, a first algorithm can comprise a basic algorithm that begins by searching for a good fit between likely beat event data and a windowed periodic beat pattern function. After establishing an initial tempo and phase, the beat pattern window can be gradually widened as gradient descent is used to find a smoothly varying tempo function that maps likely beat events to predicted beat locations.

A second algorithm can be based on the first, but adds an additional constraint that similar segments of music should have corresponding beats and tempo variation. The beat tracking algorithm can be modified to incorporate this heuristic, resulting in significant performance improvement. Further details with respect to beat tracking can be found in “TOWARD AUTOMATED HOLISTIC BEAT TRACKING, MUSIC ANALYSIS, AND UNDERSTANDING”, by Roger B. Dannenberg (2005), the contents of which is incorporated by reference in its entirety. Once the beat of the media content has been established, the media content can be correlated to different types of music (e.g., different types of music generally have different beats that are distinguishable from one another).

As will be appreciated, any means for determining or deriving a characteristic of media content may be used without departing from the scope of the invention.

After the characteristics of the media content have been determined or derived, the media content can be tagged with the analyzed data (e.g., the derived or determined characteristics can be attached to the media content itself in the form of metadata), as indicated at block 74. Alternatively, or in conjunction with, the media content can be classified into groups (e.g., dance music, instrumental, speech, hard rock, action video, still video, etc.). At block 76, the tagged media content and/or groups of media content are compared to the predetermined criteria, and those that match or are similar to the predefined criteria can be used to build a media content play list, as indicated at block 76.

For example, if the predefined criterion is rock music, then the mobile telephone 10 may select from the media content classified as rock music. The selection of media content that satisfies the criteria may be random, based on play time (e.g., shorter length content played before longer length content), alphabetical (e.g., artist name, media content name), or based on some other criteria. Further, a user may specify rules for selecting the media content, as indicated at block 78. For example, the user may wish to create a play list that includes media content sufficient to fill a one-hour time period (e.g., the user may have a one-hour commute each day). To create a play list, the user may identify the type of media content, and the desired play time. The mobile telephone 10 then would not only look for media content that matches the predefined criteria (rock music in the present example), but also select a plurality of media content that will provide a play time that satisfies the user specified time.

In building a play list, other criteria may be considered to enhance the experience created by the play list. The aforementioned rules may be created or known, and these rules may be used to construct the play list. The rules may be based on external information, e.g., interviews with a particular artist and/or inputs or preferences from a famous DJ. For example, it may be known that certain combinations work well together. It may be known that when media content “A” is played, it is preferred that media content “B” immediately follow media content “A”. Thus, whenever media content “A” is selected in the play list, media content “B” also will be selected, even if it does not fit other criteria (e.g., even if media content “A” and “B” have a different tempo or are classified in different genres). As will be appreciated, any number of rules may be implemented for creating the play list.

Additionally, as a play list is being created, the mobile phone 10 may recommend additional media content not stored in memory 18 of the mobile phone 10 as indicated at block 80. For example, once the predetermined criteria have been established, the mobile phone 10 may create a preliminary play list, and then search on-line media content sites (e.g., an on-line music site) for media content that matches the user's criteria. The mobile phone 10, in addition to the user's criteria, also may apply other rules in determining which media content to recommend (e.g., newly released media content, popular media content, media content from a particular era, etc.).

Once the mobile telephone 10 identifies some additional media content that satisfies the predetermined criteria and rules, it may prompt the user to purchase this additional media content. If the user elects to purchase the content, the mobile phone 10 may connect the user to an on-line pay site to pay for the media content. Once the user has paid, the media content may be transferred to the mobile telephone 10 and included in the play list. At block 82, the play list is presented to the user for play on the mobile telephone 10.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method for creating a media content play list using electronic equipment, comprising:
analyzing the media content to develop an identifier indicative of a characteristic of the media content; and
creating the media content play list based on a correlation between the identifier and a predefined characteristic or criteria.

2. The method of claim 1, wherein analyzing the media content to develop the identifier includes using at least one of a spectrum analyzer or a beat tracker to develop the identifier.

3. The method of claim 2, wherein using the beat tracker includes using multiple beat tracking algorithms to identify a beat of the media content.

4. The method of claim 1, wherein analyzing the media content includes classifying the media content into groups based on the identifier.

5. The method of claim 4, wherein creating the media content play list includes selecting media content from groups that are the same or similar to the predefined characteristics.

6. The method of claim 1, wherein creating the media content play list includes applying user definable rules to create the play list.

7. The method of claim 1, wherein creating the media content play list includes obtaining or deriving the predefined characteristic from data remote from the electronic equipment.

8. The method of claim 1, further comprising making the predefined characteristic available to a plurality of electronic equipment.

9. The method of claim 1, wherein creating the media content play list further includes using metadata to create the play list.

10. The method of claim 1, wherein the predefined characteristic is defined by a key word entered into the electronic equipment or a category selectable from a plurality of predefined categories on the electronic equipment.

12. The method of claim 1, wherein the media content comprises at least one of audio content or video content.

13. The method of claim 1, wherein creating the media content play list includes suggesting media content not stored on the electronic equipment.

14. The method of claim 13, further comprising purchasing the suggested media content.

15. A method of creating a media content play list using electronic equipment, comprising:
determining at least one audible or visual characteristic of media content stored on or available to the electronic equipment; and
creating the media content play list based on a correlation between the at least one audible or visual characteristic and a predefined characteristic, rule or criteria.

16. An electronic equipment, comprising:
a radio circuit operative to establish wireless communications with other electronic equipment; and
a play list creation circuit operative to analyze media content to develop an identifier indicative of a characteristic of the media content, and to create a media content play list based on a correlation between the identifier and a predefined characteristic or criteria.

17. The electronic equipment of claim 16, wherein the play list creation circuit comprises at least one of a spectrum analyzer or a beat tracker.

18. The electronic equipment of claim 16, wherein the media content comprises at least one of audio content or video content.

19. The electronic equipment of claim 18, wherein the beat tracker includes multiple beat tracking algorithms.

20. The electronic equipment of claim 16, wherein the play list creation circuit classifies the media content into groups based on the identifier.

21. The electronic equipment of claim 20, wherein the play list creation circuit selects media content from groups that are the same or similar to the predefined characteristics.

22. The electronic equipment of claim 16, wherein the play list creation circuit further applies predefined rules to create the play list.

23. The electronic equipment of claim 16, wherein the play list creation circuit is operative to obtain or derive the predefined characteristic from data remote from the electronic equipment.

24. The electronic equipment of claim 16, wherein the play list creation circuit is operative to suggest media content not stored on the electronic equipment.

25. The electronic equipment of claim 16, wherein the electronic equipment is a mobile telephone.

26. A computer program embodied in a computer readable medium for creating a media content play list using electronic equipment, comprising:
code that analyzes the media content to develop an identifier indicative of a characteristic of the media content; and
code that creates the media content play list based on a correlation between the identifier and a predefined characteristic, rule or criteria.
